(19) United States
(12) Patent Application Publication
(10) Pub. No.: US 2012/0167145 A1
(43) Pub. Date: Jun. 28, 2012

(54) METHOD AND APPARATUS FOR PROVIDING OR UTILIZING INTERACTIVE VIDEO WITH TAGGED OBJECTS

(75) Inventor: Andrew Incorvia, Fort Lauderdale, FL (US)

(73) Assignee: White Square Media, LLC

(21) Appl. No.: 12/979,759

(22) Filed: Dec. 28, 2010

(51) Int. Cl. H04N 5/445

(52) U.S. Cl. 725/60

(57) ABSTRACT

A method for utilizing interactive video with tagged objects may include receiving video data including both video media and an interactive video layer and receiving a user input selecting a selectable video object from the interactive video layer during rendering of the video data. The selectable video object may correspond to an object mapped to a corresponding identifier associated with additional information about the object. The selectable object may be selectable from the interactive video layer during rendering of the video data. The method may further include executing an object function call corresponding to the user selectable video object. The object function call may define an action to be performed responsive to user selection of the selectable video object. A corresponding apparatus and a method and apparatus for providing the interactive video with tagged objects are also provided.

### TECHNOLOGICAL FIELD

An embodiment of the present invention relates generally to video processing technology and, more particularly, relates to a method and apparatus for providing or utilizing interactive video with tagged objects.

### BACKGROUND

For many years, people have looked to television and movies for entertainment. Early on, it became clear that viewers of television programming and film have a tendency to develop an interest in various aspects of the lives of the characters, both real and fictional, that they encounter in television programs and movies. From hairstyles and fashion trends to the products that characters use or encounter in a given program or movie, viewers have long been influenced in their social and economic behavior by what they see on their televisions and at movie theaters.

Commercials have long been used by marketers and product manufacturers to raise consumer awareness of products and services by overtly advertising between programming segments on television. However, many consumers view commercials as unwanted interruptions and modern technology is fast enabling many consumers to avoid watching commercials at all or at least reduce their exposure. Moreover, commercials typically do not appear in movies presented at movie theaters. Accordingly, marketers developed another way to get their products in front of consumers by employing product placement within television programs and movies.

Product placement is often most noticeable when a character uses or is at least obviously proximate to a well known branded product. Cereal boxes, soda cans, magazines and other clearly marked products may find their way into television programs and movies. However, many other products that may appear in television programs or movies may be much less easily identifiable. For example, shoes, handbags, watches, specific clothing items, and many other products that are used in television programs or films often do not have brand or product names prominently displayed thereon. Some interested viewers may be able to spot certain brands instantly, but certainly average viewers are likely to have some difficulty identifying some products. Thus, if viewers are interested in certain products, they may find it difficult to identify and learn about those products.

The Internet may be a valuable resource in some cases. For example, if a viewer remembers a particular item that was seen, the viewer may be able to conduct an Internet search to see if anyone else has identified the item in question. However, this type of searching may be fruitless and in some cases, may provide incorrect information. Accordingly, it may be desirable to provide an improved mechanism by which viewers can identify and obtain additional information about items encountered while viewing various forms of video media.

### BRIEF SUMMARY

Methods and apparatuses are therefore provided to enable users to obtain information about items that appear in video media. In this regard, for example, some embodiments may provide for an interactive video layer to enable objects in video to be identified and tracked and, in some cases, also enable users to interact with the object. Thus, some example embodiments may provide an interactive video system that enables users to obtain information about objects that are tagged within video media being rendered. The users may select tagged objects to receive additional information and, in some cases, purchase objects. Accordingly, some embodiments may expand e-commerce and advertising medium to video.

In one example embodiment, a method of utilizing interactive video with tagged objects is provided. The method may include receiving video data including both video media and an interactive video layer and receiving a user input selecting a selectable video object from the interactive video layer during rendering of the video data. The selectable video object may correspond to an object mapped to a corresponding identifier associated with additional information about the object. The selectable object may be selectable from the interactive video layer during rendering of the video data. The method may further include executing an object function call corresponding to the user selectable video object. The object function call may define an action to be performed responsive to user selection of the selectable video object.

In another example embodiment, an apparatus for utilizing interactive video with tagged objects is provided. The apparatus may include processing circuitry configured to perform at least receiving video data including both video media and an interactive video layer and receiving a user input selecting a selectable video object from the interactive video layer during rendering of the video data. The selectable video object may correspond to an object mapped to a corresponding identifier associated with additional information about the object.

The selectable object may be selectable from the interactive video layer during rendering of the video data. The processing circuitry may further cause the apparatus to execute an object function call corresponding to the user selectable video object. The object function call may define an action to be performed responsive to user selection of the selectable video object.

In one example embodiment, a method for providing interactive video with tagged objects is provided. The method may include receiving video media including a plurality of objects within various frames of the video media, and processing the video media to generate video data that includes both the video media and an interactive video layer. The processing may include mapping an object among the plurality of objects to a corresponding identifier associated with additional information about the object, defining a selectable video object corresponding to the mapped object in which the selectable object is selectable from the interactive video layer during rendering of the video data, and defining an object function call for the user selectable video object in which the object function call defines an action to be performed responsive to user selection of the selectable video object.

In another example embodiment, an apparatus for providing interactive video with tagged objects is provided. The apparatus may include processing circuitry configured to perform at least receiving video media including a plurality of objects within various frames of the video media, and processing the video media to generate video data that includes both the video media and an interactive video layer. The processing may include mapping an object among the plurality of objects to a corresponding identifier associated with additional information about the object, defining a selectable video object corresponding to the mapped object in which the selectable object is selectable from the interactive video layer during rendering of the video data, and defining an object function call for the user selectable video object in which the object function call defines an action to be performed responsive to user selection of the selectable video object.

An example embodiment of the invention may provide a method, apparatus and computer program product for employment in mobile environments or in fixed environments. As a result, for example, media playback devices of various types may enable users to enjoy an improved interactive experience with the media they consume.

### BRIEF DESCRIPTION OF THE DRAWING(S)

Having thus described some embodiments of the invention in general terms, reference will now be made to the accompanying drawings, which are not necessarily drawn to scale, and wherein:

FIG. 1 is a schematic block diagram of a system according to an example embodiment of the present invention;

FIG. 2 illustrates an example of a mapped video object in a particular image frame according to an example embodiment of the present invention;

FIG. 3 illustrates an example of a video frame in which various object selection markers are displayed according to an example embodiment of the present invention;

FIG. 4 illustrates a generic example of an information panel 50 according to an example embodiment of the present invention;

FIG. 5 illustrates a block diagram of an apparatus for providing interactive video with tagged objects according to an example embodiment of the present invention;

FIG. 6 illustrates a block diagram of an apparatus for utilizing interactive video with tagged objects according to an example embodiment of the present invention;

FIG. 7 is a flowchart according to an example method for providing interactive video with tagged objects according to an example embodiment of the present invention; and

FIG. 8 is a flowchart according to an example method for utilizing interactive video with tagged objects according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

As used herein, the term ‘circuitry’ refers to hardware-only circuit implementations (e.g., implementations in analog circuitry and/or digital circuitry), combinations of circuits and software and/or firmware instructions stored on one or more non-transitory computer readable memories that work together to cause an apparatus to perform one or more functions described herein, and circuits, such as, for example, a microprocessor or a portion of a microprocessor, that requires software or firmware for operation even if the software or firmware is not physically present. As defined herein a “computer-readable storage medium,” which refers to a non-transitory, physical storage medium (e.g., volatile or non-volatile memory device), can be differentiated from a “computer-readable transmission medium,” which refers to an electromagnetic signal.

As indicated above, some embodiments of the present invention may relate to the provision of an interactive video system that enables users to trigger an action response when a tagged object is selected. In some examples, the triggering of the action response may occur responsive to an object function call that may obtain information about objects that are tagged within video media being rendered, or cause other events to be triggered (e.g., operation of a piece of equipment, execution of an order, purchasing an item, etc.). The tagged objects may be selected by users to access additional information and, in some cases, enable the users to access opportunities to purchase the objects. The video media may include any type of video that may be rendered at a display terminal such as a television, portable digital assistant (PDA), mobile television, mobile telephone, gaming device, laptop computer, video player, or any combination of the aforementioned, and other types of multimedia playback devices. Thus, for example, the video media may include streaming video, digital video disc (DVD) video, Blu-ray Disc (BD) video, MP3, MP4, or any other video content associated with any known video format.

The video media may be processed to tag objects within the video frames to create an interactive video layer. The user may then interact with the tagged objects and/or conduct searches relative to the objects. The processing of the video media may include encoding of the video data to allow playback of the video data with the interactive video layer therein. In some cases, a device capable of encoding the interactive video layer may display indications of the tagged objects (although such indications may be hidden if the user desires) so that the user may select the indications to access further information about the corresponding tagged object or trigger an event related to the object. Each tagged object (or mapped video object) may be associated with a unique identifier such that information associated with each mapped video object can be stored in a database and accessible via reference to the corresponding unique object identifier. The information may include details regarding a description of the object (e.g., size or size options, style or style options, brand name, model name, price, availability, reviews, etc.). In some cases, the information may also include a link to facilitate purchasing the object.

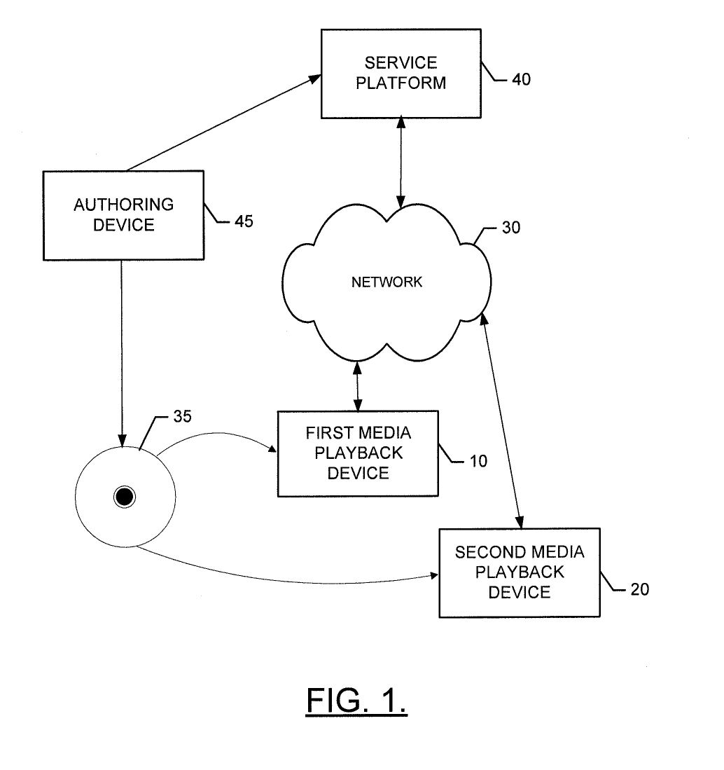

FIG. 1 illustrates a generic system diagram illustrating some alternative system architectures that may support some example embodiments. In this regard, as shown in FIG. 1, a system in accordance with an example embodiment of the present invention may include one or more media playback devices (e.g., a first media playback device 10 and a second media playback device 20) that may each be capable of rendering video data according to an example embodiment. The video data that may be rendered by the media playback devices may be provided thereto in any of a number of different formats. For example, in some cases, one or more of the media playback devices may be configured to support playback of video data provided via a network 30 or read from any of various computer readable storage media such as DVD, BD, flash memory or other storage memory devices that may store video data in any of a plurality of formats that may be decoded and rendered by the media playback devices. Media storage device 35 is an example of such computer readable storage media.

The second media playback device 20 is provided as an example to illustrate potential multiplicity with respect to instances of other devices that may be capable of communication with the network 30 or rendering video data from the media storage device 35 and that may practice an example embodiment. The media playback devices of the system may be able to communicate with network devices or with each other via the network 30 in some situations. In some cases, the network devices with which the media playback devices of the system communicate may include a service platform 40 from which information can be pulled, or from which information may be pushed. In an example embodiment, the media playback devices may be enabled to communicate with the service platform 40 to provide, request and/or receive information.

As indicated above, the first and second media playback devices 10 and 20 that are illustrated may be examples of display terminals that can handle video data of various types such as streaming video, DVD video, BD video, MP3, MP4, or any other video content associated with any known video format. In some embodiments, the first and second media playback devices 10 and 20 may be interactive video players, meaning that the user can in some way interact with the video data that is being presented by the first and second media playback devices. An interactive video player may include some form of user interface (e.g., mouse, touch screen, joystick, voice recognition, wireless pointer, menu selection device such as a remote control or other input device) to enable user selections to be provided with respect to objects that are tagged within the interactive video layer of the video data being rendered. It should also be noted that the first and second media playback devices 10 and 20 may be either mobile or fixed devices in some examples. However, is should also be noted that not all systems that employ embodiments of the present invention may comprise all the devices illustrated and/or described herein.

In an example embodiment, the network 30 includes a collection of various different nodes, devices or functions that are capable of communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of wireless or wired communication protocols. Thus, in some examples, one or more of the first and second media playback devices 10 and 20 may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices or elements (e.g., personal computers, server computers or the like) may be coupled to the first and second media playback devices 10 and 20 via the network 30. By directly or indirectly connecting the first and second media playback devices 10 and 20 and other devices to the network 30, the first and second media playback devices 10 and 20 may be enabled to communicate with the other devices (or each other), for example, according to numerous communication protocols including Hypertext Transfer Protocol (HTTP) and/or the like, to thereby carry out various communication or other functions of the first and second media playback devices 10 and 20, respectively.

Furthermore, although not shown in FIG. 1, the first and second media playback devices 10 and 20 may communicate in accordance with, for example, radio frequency (RF), Bluetooth (BT), Infrared (IR) or any of a number of different wireline or wireless communication techniques, including USB, LAN, wireless LAN (WLAN), Worldwide Interoperability for Microwave Access (WiMAX), WiFi, ultra-wide band (UWB), Wibree techniques and/or the like. As such, the first and second media playback devices 10 and 20 may be enabled to communicate with the network 30 by any of numerous different access mechanisms. For example, mobile access mechanisms such as wideband code division multiple access (W-CDMA), CDMA2000, global system for mobile communications (GSM), general packet radio service (GPRS), long term evolution (LTE) and/or the like may be supported as well as wireless access mechanisms such as WLAN, WiMAX, and/or the like and fixed access mechanisms such as digital subscriber line (DSL), cable modems, Ethernet and/or the like.

In an example embodiment, the service platform 40 may be a device or node such as a server or other processing device. The service platform 40 may have any number of functions or associations with various services. As such, for example, the service platform 40 may be a platform such as a dedicated server (or server bank) associated with a particular information source or service (e.g., a streaming video content provision service), or the service platform 40 may be a backend server associated with one or more other functions or services. As such, the service platform 40 represents a potential host for a plurality of different services or information sources. Moreover, in some cases, the service platform 40 may represent multiple entities (e.g., a warehouse or other entity associated with storing various types of content and an entity associated with distribution of various types of content) and thus, communications and/or exchanges internal to the service platform 40 may actually include communications and/or exchanges between separate entities and/or organizations. In some embodiments, the functionality of the service platform 40 is provided by hardware and/or software components configured to operate in accordance with known techniques for the provision of information to users of communication devices. However, at least some of the functionality provided by the service platform 40 may be information provided in accordance with an example embodiment of the present invention.

In an example embodiment, an authoring device 45 may also be included in the system. The authoring device 45 may be configured to process video media to produce video data including the interactive video layer as described above. Thus, the authoring device 45 may be configured to enable an operator to define the interactive video layer as an interactive layer above a video screen display. Thus, video data generated responsive to processing by the authoring device 45 may include typical video media including, for example, video data descriptive of a sequence of image frames that can be played back, but may also include the interactive video layer in addition to the video media. As such, the interactive video layer may be encoded along with the video media to create video data that is essentially specially encoded interactive video layer-encoded video.

The authoring device 45 may include hardware and software developed to enable identification and mapping of an action event to a declared video object with which users may thereafter be enabled to interact and search with respect to. The authoring device 45 may be configured to connect to (or generate) a database that may catalog a plurality of items, each of which may correspond to a unique identifier (e.g., an object identifier), according to the respective unique identifiers of the items (or objects). In some cases, the unique identifier for a particular object can then be reused in a plurality of different video data sequences. For example, a common object such as a brand name soda product may be identified in an interactive video layer associated with a certain video sequence. The unique identifier for the brand name soda product may then be stored in the database so that if other video sequences are to have the same object tagged in the interactive video layer of the corresponding video sequences, the stored unique identifier may simply be reused. In some cases, the stored unique identifiers may be modified and a modified version may be stored also (e.g., for a diet version of the same brand name soda product). In some other cases, the modified versions may also be associated with specific promotions, special vendors, and/or the like. The unique identifiers may each be tied to a corresponding information panel providing information about the corresponding object.

For each individual video sequence that the authoring device 45 processes to add an interactive video layer, the authoring device 45 may be configured to enable the operator to define interactive objects to be encoded into the interactive video layer. The interactive objects may be defined as mapped video objects to identify objects by a sequence number or object number in combination with a set of coordinates that indicate position in a frame that can be defined as a single object that can be acted upon by an object function call. The object function call may define a user desired action to be performed with respect to a mapped video object that has been defined and activated (thereby creating a selectable video object). A mapped video object may include at least three pieces of information such as, for example, a method that defines a pixel(or pixels) on a video display screen (e.g., via an x/y coordinate grid, an x/y/z coordinate grid for a three dimensional system or via pixel identifiers), a time component or frame sequence number, and a video object identifier. The video object identifier may be may be a standard code associated with an object within a video sequence. The video object identifier may therefore include a unique code or identifier and corresponding descriptive terms to describe the corresponding object.

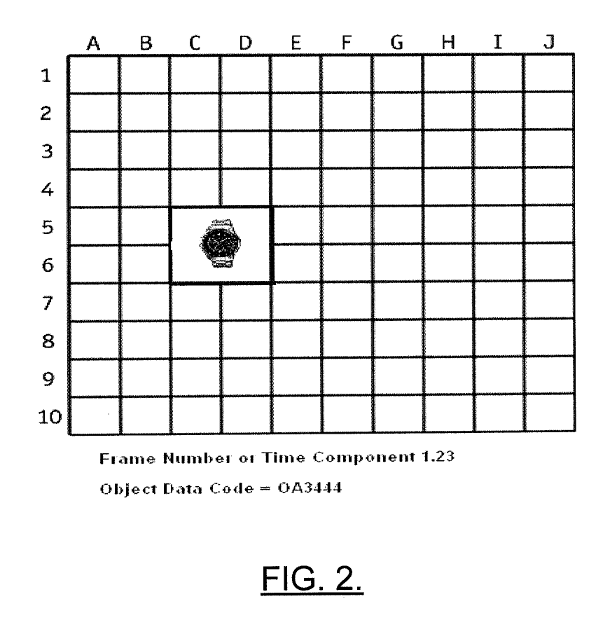

In an example embodiment, a mapped video object may include a grid location defined according to a basic coordinate system to identify a location of an object within a particular frame. The coordinates of the object and the frame sequence or time component (e.g., a time elapse number) may then be assigned a database index code (e.g., the video object identifier). In some cases, object may move from frame to frame and thus the coordinates of the object and the frame sequence or time component information may change over time. However, the video object identifier will remain the same as it uniquely identifies the corresponding object. The video object identifier for a certain object may appear in one or more series of frames at the same or different locations. Thus, for example, a particular video object identifier may appear for a series of ten frames in the same location and then be not appear for many frames but reappear in another location thereafter and be present for another ten frames although the location of the video object identifier may change in some or all of the additional ten frames. FIG. 2 illustrates an example of a mapped video object (in this case a watch) in a particular image frame. As is shown in FIG. 2, a generic coordinate system is defined with x coordinates being letters from A to J and the y coordinates being numbers from 1 to 10. In this example, a frame number or time component may identify the frame shown in FIG. 2. Meanwhile, coordinates may be provided to identify corners defining the object, a center of the object or any other suitable position marker to identify object location within the coordinate structure provided. The video object identifier (in this example, the object data code OA3444) may also be provided to identify the specific object that is located at the corresponding coordinates at the given frame or time. Thus, in some example embodiments, a minimum number of pixels (e.g., one) or one x/y locator may be used to tag an object in order to enable efficient identification of object location. As such, the interactive video layer, and the amount of data associated therewith, may be kept relatively free of excessive amounts of additional data.

Generally speaking, the video object identifier may allow a mapped video object to be linked to static, dynamic or a combination of static and dynamic databases or become a variable that can be passed programmatically to another function such as a script. Thus, for example, when a user selects an object and an object function call is triggered, data may not be queried from a database, but instead the code OA3444 may be passed to another process that is executed or running and waiting for a variable to be passed. Thus, for example, mapped video objects may remain independent from the information associated with the object and therefore all information associated with an object need not be embedded into a separate stream. As an example, a particular dress (e.g., a red dress) may be marketed exclusively for a particular department store. If the particular department store is acquired by another entity that intends to rebrand stores associated with the particular department store, the information associated with a mapped video object might otherwise typically be obsolete since it would be associated at the video layer with a store that no longer exists. By including the unique video object identifier that is associated with the particular department store, the mapped video object could be maintained, but the information associated with the video object identifier may be updated to reflect a new department store affiliation. Thus, for example, when data changes for the product, the information associated with the video object identifier can be updated or replaced within the mapped video object and all video objects associated with the video object identifier that has been replaced may be updated in one place. Objects may also appear in many videos, and thus a programmer compiling an interactive video may be able to look up a reference code to automatically assign attributes to an object in a predefined manner to cut down on the cost and time associated with compilation development.

Once an object is defined as a mapped video object and activated for user selection, the object may be referred to as a selectable video object. Any of a plurality of different programming languages may be used to create an interactive video layer interface including selectable video objects (e.g., Flash, HTML, Java, any combination of languages and/or the like). As an example, an action item may be placed on or near the object. When the action item is selected via a user input, an object function call may be initiated. The object function call may cause an interface control console or window (e.g., a popup) to display additional information about the object(s) associated with the selectable video object in an information panel. Alternatively or additionally, the object function call may trigger another event (i.e., action to another device such as placing a call, connecting to a website, placing an order, etc.). The information panel may be displayed in the foreground relative to the video being played back. However, the information panel may alternatively be displayed in a separate portion of the display (e.g., in a separate viewing window, or separate portion of the video display screen). In some cases, the video may pause (or slow) while the additional information can be reviewed. However, in other cases, the user may simply be presented with an option to pause (or slow) the video while the additional information is reviewed. In some embodiments, more than one information panel providing the additional information may be presented at any given time. Thus, for example, the user may query for information regarding a plurality of objects within a particular video sequence.

In some embodiments, rather than immediately displaying the information panel in response to a user selection of a selectable video object, a list may be generated of selectable video objects that have been selected. At any time (e.g., at a convenient time to pause the video, at the end of the video, or even at a later time such as when network connectivity is available), the user may review the list and select specific items from the list to see the corresponding information panel associated with each respective item.

In an example embodiment, each selectable video object may have an object selection marker placed on or near it. The object selection marker may be a geometric shape surrounding the corresponding object, or may be some other type of identifier to identify the selectable video object. Thus, for example, the user may select a selectable video object by clicking on, touching or otherwise selecting the selectable video object whose presence is announced by the corresponding object selection marker. In some embodiments, the object selection markers used for various objects may be generic (e.g., in the form of a shape, cross, arrow, or icon that appears on, near or pointing to the object that forms the subject of a selectable video object). By placing the object selection markers next to the objects to which they correlate (instead of placing a geometric shape over or around such objects), the view of such objects may not be obscured. Moreover, by using an arrow to indicate which object is associated with an object selection marker, ambiguity as to which product any particular marker corresponds may be removed.

In some embodiments, as indicated above, a single object selection marker shape or style (i.e., a generic object selection marker) may be used for all items. However, in other cases, the object selection markers may have different characteristics based on the objects to which they correspond. In this regard, a particular object selection marker (or a particular characteristic of an object selection marker such as color) may be unique to each of various different types of items (or brands). Thus, for example, shoes could have a unique object selection marker while clothing items, accessories, makeup, household goods, food items, cleaning products, and numerous other types of items could each have their own respective unique object selection markers (or characteristics of object selection markers). Moreover, in some cases, a company or product logo or trademark symbol may be used as the object selection marker associated with a selectable video object.

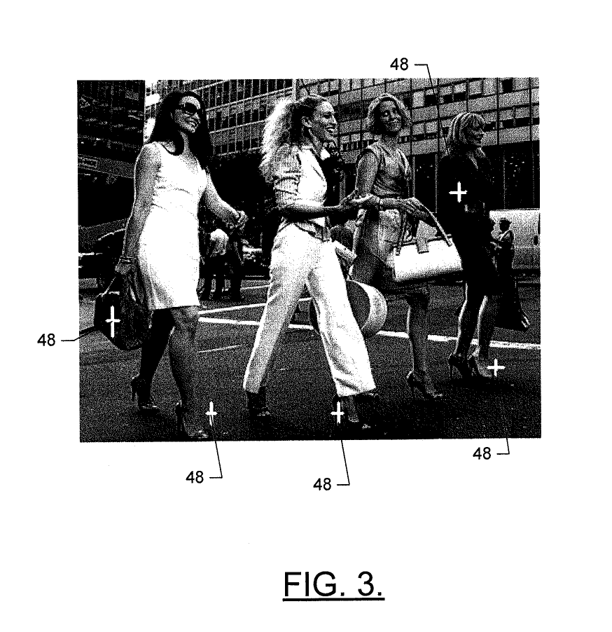

In an example embodiment, the object selection marker characteristics may be determined and fixed at the authoring end (e.g., by the authoring device 45). However, in some embodiments, the end user (e.g., the consumer or customer) may actually tailor characteristics of the object selection markers to their own taste based on options provided when creating the interactive video layer at the authoring end. For example, when authoring, various different possible object selection markers could be provided in a list that the end user can access to assign desirable object selection markers to corresponding different products. Moreover, the end user may be allowed to enable or disable various levels or types of object selection marker representations. Thus, the end user could, for example, enable trademark symbols for use as object selection markers or limit all object selection markers to a single simple form (e.g., a cross as shown below in FIG. 3).

Many other selection options may also be provided with respect to defining allowable forms or controls for the object selection markers. Other features of or relating to the object selection markers that could also be controlled by the end user may include turning object selection markers on or off globally, providing for display of object selection markers only when a selectable video object is hovered over (e.g., by a mouse, joystick or finger), defining a desired response to selection of the object selection markers (e.g., pausing or slowing video playback), assigning varying levels of transparency to the object selection markers, and/or the like. Thus, in some embodiments, the object selection marker may not need to get passed or embedded in the interactive video layer. Instead, the layer may merely need to be aware of the location of a marker should one need to be visible. This may allow for the interchangeability of markers on demand, unless hardcoded and not changeable for specific reasons. Of note, since the object selection marker merely announces the presence of the selectable video object, turning the object selection markers off or making them fully transparent does not prevent the end user from selecting a selectable video object. Indeed, the selectable video object's presence is not impacted by the state of the object selection marker that corresponds thereto. As such, in a mode in which the object selection markers are not visible, the user may select various items and, if such items correspond to selectable video objects a corresponding information panel for the object will be provided. However, if such items do not correspond to selectable video object, then there may be no response to attempts at selection.

Notably, as indicated above, voice recognition commands may also be used in some embodiments. Accordingly, some example embodiments may present a unique code (e.g., a series of numbers and/or letters or a particular symbol or sequence of symbols) as the object selection marker for each item so that the code can be spoken in order to select a corresponding item and retrieve the corresponding information panel for the item.

FIG. 3 illustrates an example of a video frame in which various object selection markers 48 are displayed. The object selection markers 48 of FIG. 3 are associated with (and placed nearby) shoes, handbags and clothing items of the individuals shown. As the respective items associated with the object selection markers move from frame to frame, the corresponding object selection markers 48 may move as well in order to keep each object selection marker 48 proximate to the item to which it is associated. In response to selection of one (or more) of the object selection markers, the corresponding selectable video object may trigger an object function call. The object function call causes the system to retrieve the additional information (e.g., on the information panel) associated with the corresponding selected mapped video object by retrieving the corresponding identifier of the mapped video object from memory and the information associated with that identifier.

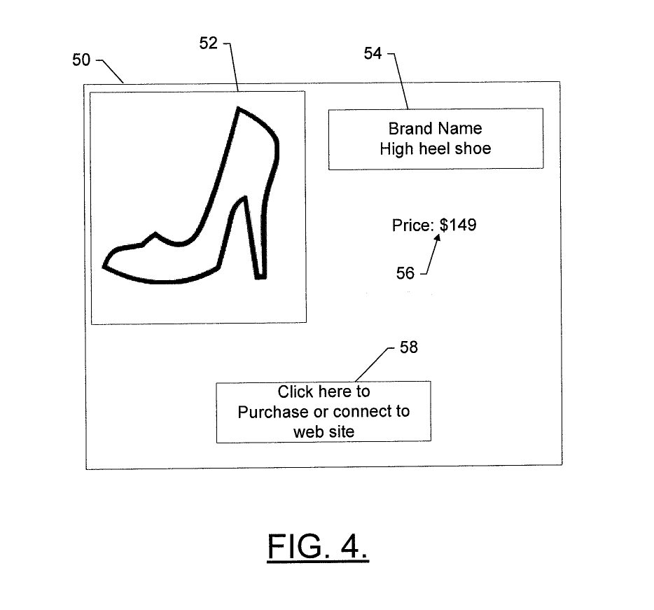

FIG. 4 illustrates a generic example of an information panel 50 according to an example embodiment. As shown in FIG. 4, the information panel 50 may include a product image 52, a text description of the product 54, price information 56, and/or purchase information 58 (e.g., a link to directions to a store that has the product in stock or carries the product line, a link to a web site of a store that carries the product line, a link to a web site from which the product may be purchased, direct purchase without leaving the display screen, clicking on a phone icon to place a call using VoIP, and/or the like). In some embodiments, the information panel 50 may further include information to enable book marking of an item to make it easy to find later on or to enable marking of the item as a favorite. However, it should be appreciated that since the information panel 50 may correspond to any of a number of different types of products, and in some cases also to services, music and even locations, the contents of the information panel 50 may vary according to the specific embodiment employed. Furthermore, it should be appreciated that some items that aren't associated with a particular definable grid location in an image frame (e.g., the theme music or perhaps the name of the location), the information panel 50 for such items may be accessible by selecting an object selection marker (or a hotspot near such marker) that has a distinctive marking (e.g., a musical note for music or a map icon for location). Information about the corresponding song (e.g., artist, album, price, purchase information, etc.) or location (e.g., directions, tourist information, hours of operation, map location, travel arrangement information, ticket purchasing options, etc.) may then be provided on the information panel 50.

Of note, since the information panel 50 may be defined by the authoring device 45 before the interactive video layer is actually encoded with the video media, the video data that the end user receives has complete information on the product in the form of the information on the information panel 50 without reliance on a separate stream of information or any form of network connectivity. Thus, for example, if the first or second media playback device 10 or 20 is accessing the interactive video layer via video data that is not being currently streamed (e.g., from a previous download, or from a DVD or BD), there is no need for current Internet connectivity to enable the user to retrieve information about the products with which any particular information panel 50 is associated. The only possible exception to this is when the user selects purchase information 58 and the purchase information 58 provides a link to a web page via a URL (for directions, store location, or direct purchase opportunities). When purchase information 58 requiring a network connection is requested, a connection may automatically be established (if possible) or the user may be asked either to establish a connection or whether it is acceptable for the device to attempt to establish a connection. In some cases, retrieval of purchase information 58 may be deferred until network connectivity is established (or restored). Moreover, although some media formats (e.g., BD or DVD) may not typically require any network connectivity by themselves, example embodiments may still enable interaction with the interactive video layer and therefore may enable direct or deferred access to certain information or actions via a network. Thus, for example, in some cases such devices may be enabled to poll the service platform 40 for updated information on certain objects. Deferrals may be tracked (e.g., in a queue) for execution when connectivity is established. Thus, for example, if the user later establishes network connectivity, the deferred information retrievals may automatically be initiated, or the user may be reminded of the deferred retrieval and asked whether the device should continue with such retrieval.

An example process flow may proceed as follows. For example, a user may be viewing a BD employing the interactive video layer having information associated with a database (fixed or updateable in connection with network resources) that was encoded at the time of distribution of the BD. The user may select an object and the corresponding video object identifier associated with the object may be passed. A determination may be made as to whether Internet access is available and/or whether user settings allow retrieval of updated information. If such access is permitted and available, the service platform 40 may be accessed for updated information by passing the video object identifier to the service platform 40. However, if Internet access is not available or permitted, the database may be accessed from the BD itself and corresponding information may be provided to the user.

In some embodiments, the purchase information 58 may include a direct purchase option (e.g., a “buy it” button) that may enable the user to purchase the corresponding item through a preferred vendor (e.g., at a sales price indicated in the price information 56). However, in other cases, the purchase information 58 may simply link to the corresponding vendor's web site (if network connectivity is available). As an alternative, a contact option may be provided so that the user can send an email inquiry to the corresponding vendor. Users may also be enabled to bookmark objects for later reference (e.g., for time reasons, network connectivity reasons, or other reasons).

In some embodiments, the first and second media playback devices 10 and 20 may be configured to perform object filtering. For example, in some cases, the end user may initiate object filtering in order to display only those object selection markers that correspond to enabled objects. Objects that are enabled may be selected by type from a list of types of objects, or objects may be filtered based on user preferences or past history. In some cases, the user may provide personal information (e.g., age, gender, brand preference, interests, etc.) and the filtering may be conducted based on the personal information. Thus, for example, if the user is a female, filtering may be performed to display object selection markers for women's apparel and accessory items, but not men's fashions or other items. Object filtering may be performed at varying levels from broad to granular. An example of selectable options for user selection is provided below in Table 1.

TABLE 1
Transportation
Automobiles
Planes
Boats
Trains
Bikes
Motorcycles
Apparel
Clothing
Male
Female
Neutral
Accessories
Male

In an example embodiment, the video data provided to the first and second media playback devices 10 and 20 may include an index of selectable video objects. The index may be arranged, for example, by any or all of the following including order of appearance, object classification or type, cost, alphabetical order, etc. Thus, for example, the user may (rather than watching the video) find objects via the index. In some cases, after an object is selected via the index, the user may be provided with an option to view a clip (e.g. sponsor selected or from the video itself) or see a static image frame from the video that corresponds to or displays the object. Alternatively, the user may simply start the video from that location. If the object has several different appearances, the user may be enabled to select one of the different appearance locations to view. When an object is selected from the index, the information panel 50 for the corresponding object may also be displayed, as described above.

In some embodiments, the first and second media playback devices 10 and 20 may be further configured to provide a search function for objects. For example, the user may be enabled to access a search engine (e.g., a publicly available search engine enabled to pull information from the databases of the system or a proprietary and locally operable search engine) to enter specific queries for objects. Search results may include objects that match or nearly match the query terms. Selection of the search results may open information panels for corresponding objects and/or provide information on (and/or options to access) locations of potential matching items within the video data. As such, searching can be done locally or using external resources that are enabled to access information provided in the interactive video layer.

In an example embodiment, the first and second media playback devices 10 and 20 may be configured to collect, store and/or report information on user activity. For example, information on specific products searched, selected, purchased, and/or the like, may be gathered. Other reportable information may include product search count, product click count, product view count, index navigation results, consumer navigation patterns (e.g., mouseovers on objects), click-through to purchase percentages, consumer traffic, consumer product ratings, etc. In some embodiments, the data captured may be used to identify product placement strategies for more effective future ad campaigns. In some cases, such as where a network connection is active, the collected information may be reported (e.g., to the service platform 40) substantially in real time. However, information may also be collected and stored locally for reporting in aggregate at a later date or time. Thus, for example, if network connectivity is not available or desirable (or bandwidth consumption is desired to be kept low), the information may be locally stored until an advantageous future opportunity to report the information arises.

In some embodiments, the first and second media playback devices 10 and 20 may be configured to provide legacy compatibility for older media. For example, for a DVD that was not initially produced with an interactive video layer, the authoring device 45 may be configured to develop a synchronizable interactive video layer that can be downloaded by the first or second media playback devices 10 or 20 and synchronized with the older media. After synchronization, the interactive video layer may be presented along with the video media and the user may interact with the interactive video layer as described above.

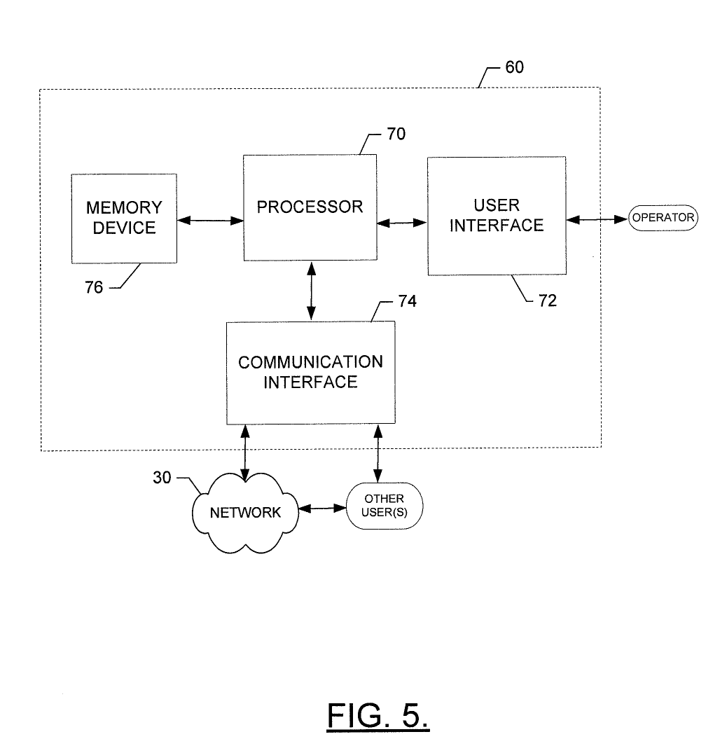

FIG. 5 illustrates a schematic block diagram of an apparatus for providing interactive video with tagged objects according to an example embodiment of the present invention. An example embodiment of the invention will now be described with reference to FIG. 5, in which certain elements of an apparatus 60 for providing interactive video with tagged objects are displayed. The apparatus 60 of FIG. 5 may be employed, for example, on the authoring device 45. However, it should be noted that the devices or elements described below may not be mandatory and thus some may be omitted in certain embodiments.

Referring now to FIG. 5, an apparatus for providing interactive video with tagged objects is provided. The apparatus 60 may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 60. The memory device 76 may include, for example, one or more volatile and/or non-volatile memories. In other words, for example, the memory device 76 may be an electronic storage device (e.g., a computer readable storage medium) to store data that may be retrievable by a machine (e.g., a computing device like the processor 70). The memory device 76 may be configured to store information, data, applications, instructions or the like for enabling the apparatus 60 to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 60 may, in some embodiments, be the authoring device 45 or a fixed communication device or computing device configured to employ an example embodiment of the present invention. However, in some embodiments, the apparatus 60 may be embodied as a chip or chip set.

The processor 70 may be embodied in a number of different ways. For example, the processor 70 may be embodied as one or more of various processing means such as a coprocessor, a microprocessor, a controller, a digital signal processor (DSP), or various other processing circuitry including integrated circuits such as, for example, an ASIC (application specific integrated circuit), an FPGA (field programmable gate array), a hardware accelerator, or the like. As such, in some embodiments, the processor 70 may include one or more processing cores configured to perform independently.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., the authoring device 45) adapted for employing an embodiment of the present invention by further configuration of the processor 70 by instructions for performing the algorithms and/or operations described herein.

Meanwhile, the communication interface 74 may be any means such as a device or circuitry embodied in either hardware, or a combination of hardware and software, that is configured to receive and/or transmit data from/to a network and/or any other device or module in communication with the apparatus 60. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. The processor 70 and/or user interface circuitry comprising the processor 70 may be configured to control one or more functions of one or more elements of the user interface 72 through computer program instructions (e.g., software and/or firmware) stored on a memory accessible to the processor 70 (e.g., memory device 76, and/or the like). An operator may be enabled, via the user interface 72, to provide instructions with respect to creation of an interactive video layer (and the corresponding mapped video objects, object function calls, selectable video objects, video object identifiers, object selection markers, information panels, etc.) as described above. The operator may then be enabled to push video data that includes video media and the interactive video layer to the service platform 40 for ultimate presentation to the user via the first media playback device 10 or the second media playback device 20, or may create or provide data for creation of the media storage device 35.

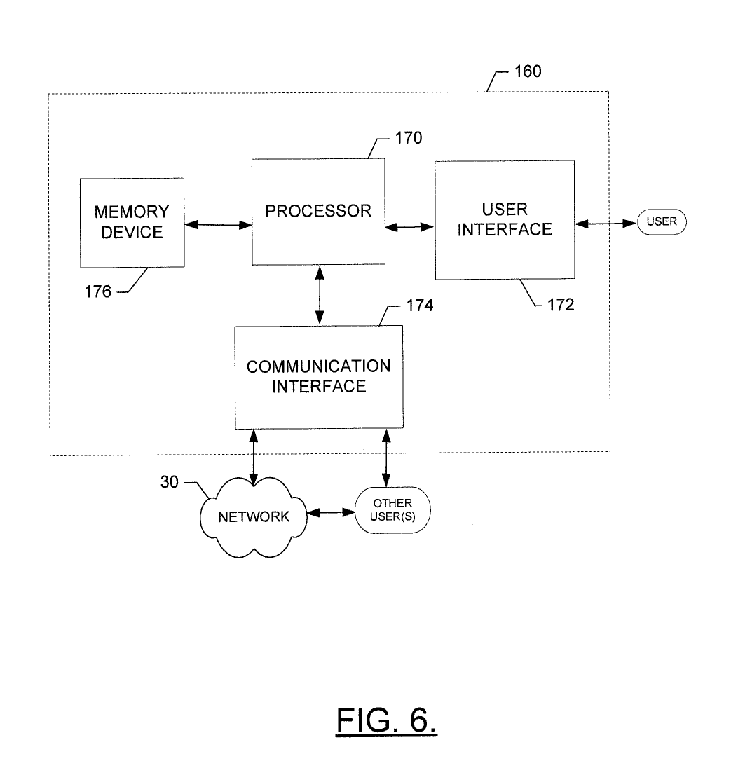

FIG. 6 illustrates a schematic block diagram of an apparatus for utilizing interactive video with tagged objects according to an example embodiment of the present invention. An example embodiment of the invention will now be described with reference to FIG. 6, in which certain elements of an apparatus 160 for utilizing interactive video with tagged objects are displayed. The apparatus 160 of FIG. 6 may be employed, for example, on the first media playback device 10 or the second media playback device 20. However, it should be noted that the devices or elements described below may not be mandatory and thus some may be omitted in certain embodiments.

Referring now to FIG. 6, an apparatus for utilizing interactive video with tagged objects is provided. The apparatus 160 may include or otherwise be in communication with a processor 170, a user interface 172, a communication interface 174 and a memory device 176. The processor 170, the user interface 172, the communication interface 174, and the memory device 176 may each be similar in general function and form to the processor 70, the user interface 72, the communication interface 74 and the memory device 76 described above (except perhaps with semantic and scale differences), so a detailed explanation of these components will not be provided. The user interface 172 may be in communication with the processor 170 to receive an indication of a user input at the user interface 172 and/or to provide an audible, visual, mechanical and/or other output to the user. As indicated above, the user input may be provided via voice commands or via any other suitable input mechanism.

As indicated above, the video data provided to the apparatus 160 may typically include the original video media and the interactive video layer. However, rather than separately streaming the video media and the interactive video layer, some example embodiments may provide the video data as a single stream. In some cases, the single stream may not be HTML based and the apparatus 160 may be configured to decode the data and manipulate the data according to user preferences and other design principles as described herein. Moreover, the playback capabilities of the apparatus 160 may be tailored to the specific device on which the playback will be provided (e.g., different playback configuration may be provided for small handheld devices versus larger platforms such as PCs). The apparatus 160 may play streamed video. However, as discussed above, some example embodiments may avoid network connectivity by playing back video content that is fully loaded onto the apparatus 160 prior to play back (e.g., with download being previously completed or by playing a DVD, BD and/or the like). In some embodiments, the video data provided to the apparatus 160 may include corresponding information for prioritized items that are part of the original media (e.g., stored on the DVD or BD) and other lower priority items may require loading of supplemental information (e.g., via a network connection). As such, preferred vendors (or those who have paid a premium for priority) may be given priority with respect to ensuring their products are supported for interaction with users when the product is played, while other vendors may have their products supported as bandwidth or network connectivity becomes available.

Accordingly, some embodiments of the present invention may enable a mechanism by which to map objects to identifiers (i.e., tag the objects) that may be tied to information and/or actions associated with the object. The information may be retrieved or the actions may be initiated without any need of a network connection, although in some cases even further capabilities may be provided with a network connection (e.g., effecting purchase of the item or finding a sales location for the item). Thus, for example, an interactive video layer may be provided that can be implemented fully or at some other user desirable level. Moreover, the interactive video layer does not need to be streamed in its entirety to a user, but can be implemented with relatively small amounts of filterable data being provided therein.

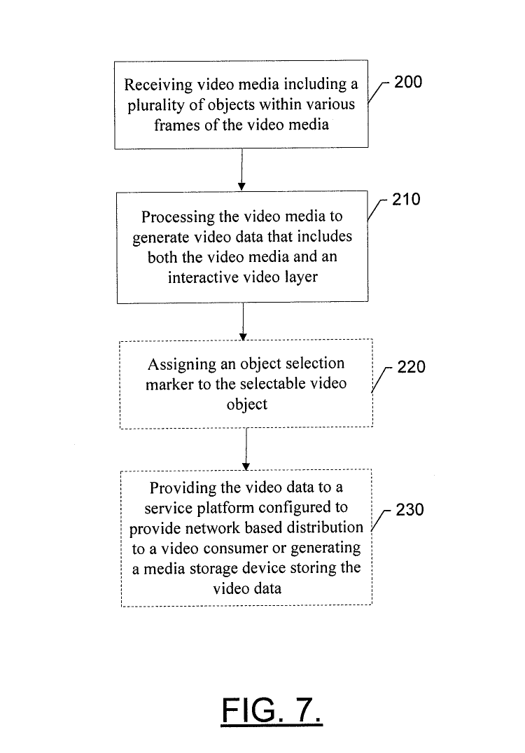

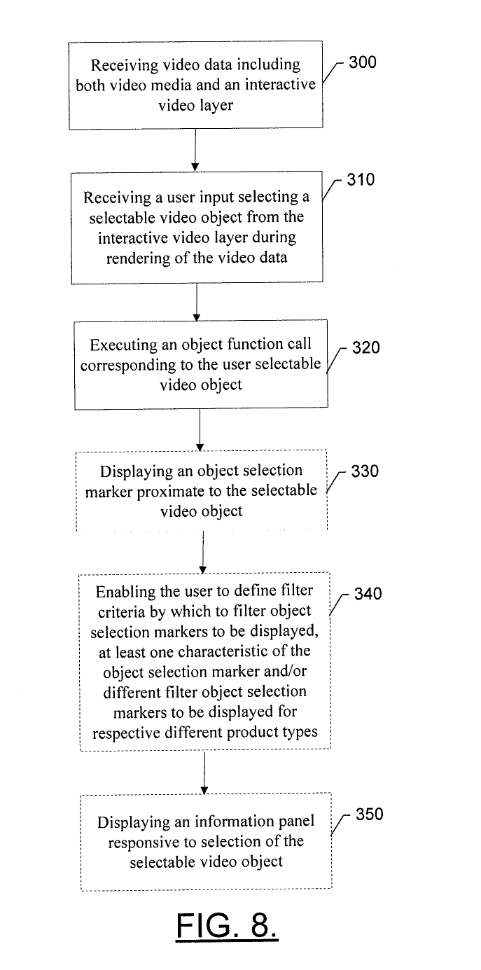

FIGS. 7 and 8 are flowcharts of a method and program product according to an example embodiment of the invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal or network device and executed by a processor in the user terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowcharts block(s). These computer program instructions may also be stored in a computer-readable memory that may direct a computer or other programmable apparatus to function in a particular manner, such that the instructions stored in the computer-readable memory produce an article of manufacture which implements the functions specified in the flowcharts block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In this regard, a method according to one embodiment of the invention from the perspective of a device such as the authoring device 45, as shown in FIG. 7, may include receiving video media including a plurality of objects within various frames of the video media at operation 200, and processing the video media to generate video data that includes both the video media and an interactive video layer at operation 210. The processing may include mapping an object among the plurality of objects to a corresponding identifier associated with additional information about the object, defining a selectable video object corresponding to the mapped object in which the selectable object is selectable from the interactive video layer during rendering of the video data, and defining an object function call for the user selectable video object in which the object function call defines an action to be performed responsive to user selection of the selectable video object.

In some embodiments, certain ones of the operations above may be modified or further amplified as described below. Moreover, in some embodiments additional optional operations may also be included (some examples of which are shown in dashed lines in FIG. 7). It should be appreciated that each of the modifications, optional additions or amplifications below may be included with the operations above either alone or in combination with any others among the features described herein. In this regard, in some embodiments the method may further include assigning an object selection marker to the selectable video object at operation 220. The object selection marker may provide a visual indication of a presence of the selectable video object on a display rendering the video data. In some cases, assigning the object selection marker may include enabling the operator to define different object selection markers to be displayed for respective different product types. In some examples, the method may further include providing the video data to a service platform configured to provide network based distribution to a video consumer or generating a media storage device storing the video data at operation 230. The media storage device may be, for example, a digital video disc or a Blu-ray disc. In some embodiments, mapping the object may include defining an information panel to be displayed responsive to selection of the selectable video object to implement the object function call. In an example embodiment, mapping the object may include indicating a coordinate location of the object within an identified frame or at an identified time.

In an example embodiment, an apparatus for performing the method of FIG. 7 above may comprise a processor (e.g., the processor 70) configured to perform some or each of the operations (200-230) described above. The processor may, for example, be configured to perform the operations (200-230) by performing hardware implemented logical functions, executing stored instructions, or executing algorithms for performing each of the operations.

A method according to one embodiment of the invention from the perspective of a device such as the first media playback device 10 or the second media playback device 20, as shown in FIG. 8, may include receiving video data including both video media and an interactive video layer at operation 300 and receiving a user input selecting a selectable video object from the interactive video layer during rendering of the video data at operation 310. The selectable video object may correspond to an object mapped to a corresponding identifier associated with additional information about the object. The selectable object may be selectable from the interactive video layer during rendering of the video data. The method may further include executing an object function call corresponding to the user selectable video object at operation 320. The object function call may define an action to be performed responsive to user selection of the selectable video object.

In some embodiments, certain ones of the operations above may be modified or further amplified as described below. Moreover, in some embodiments additional optional operations may also be included (some examples of which are shown in dashed lines in FIG. 8). It should be appreciated that each of the modifications, optional additions or amplifications below may be included with the operations above either alone or in combination with any others among the features described herein. In this regard, in some embodiments the method may further include displaying an object selection marker proximate to the selectable video object at operation 330. The object selection marker may provide a visual indication of a presence of the selectable video object on a display rendering the video data. In some embodiments, the method may further include enabling the user to define filter criteria by which to filter object selection markers to be displayed, at least one characteristic of the object selection marker and/or different filter object selection markers to be displayed for respective different product types at operation 340. In some cases, receiving the video data may include receiving the video data from a service platform configured to provide network based distribution to a video consumer or from a media storage device storing the video data. The media storage device may include, for example, a digital video disc or a Blu-ray disc. In some embodiments, the method may further include displaying an information panel responsive to selection of the selectable video object at operation 350. The information panel may include at least one of a product image, a text description of the product, price information, or purchase information. In some cases, the method may further include generating a searchable index of selectable video objects.

In an example embodiment, an apparatus for performing the method of FIG. 8 above may comprise a processor (e.g., the processor 70) configured to perform some or each of the operations (300-350) described above. The processor may, for example, be configured to perform the operations (300-350) by performing hardware implemented logical functions, executing stored instructions, or executing algorithms for performing each of the operations.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving video media including a plurality of objects within various frames of the video media; and
processing the video media to generate video data that includes both the video media and an interactive video layer, the processing including:
mapping an object among the plurality of objects to a corresponding identifier associated with additional information about the object;
defining a selectable video object corresponding to the mapped object, the selectable object being selectable from the interactive video layer during rendering of the video data; and
defining an object function call for the user selectable video object, the object function call defining an action to be performed responsive to user selection of the selectable video object.

2. The method of claim 1, further comprising assigning an object selection marker to the selectable video object, the object selection marker providing a visual indication of a presence of the selectable video object on a display rendering the video data.

3. The method of claim 2, wherein assigning the object selection marker further comprises enabling the operator to define different object selection markers to be displayed for respective different product types.

4. The method of claim 1, further comprising providing the video data to a service platform configured to provide network based distribution to a video consumer.

5. The method of claim 1, further comprising generating a media storage device storing the video data, the media storage device comprising a digital video disc or a Blu-ray disc.

6. The method of claim 1, wherein mapping the object comprises defining an information panel to be displayed responsive to selection of the selectable video object to implement the object function call.

7. The method of claim 1, wherein mapping the object comprises indicating a coordinate location of the object within an identified frame or at an identified time.

8. The method of claim 1, further comprising generating a searchable index of selectable video objects.

9. An apparatus comprising processing circuitry configured to cause the apparatus to perform at least:
receiving video media including a plurality of objects within various frames of the video media; and
processing the video media to generate video data that includes both the video media and an interactive video layer, the processing including:
mapping an object among the plurality of objects to a corresponding identifier associated with additional information about the object;
defining a selectable video object corresponding to the mapped object, the selectable object being selectable from the interactive video layer during rendering of the video data; and
defining an object function call for the user selectable video object, the object function call defining an action to be performed responsive to user selection of the selectable video object.

10. The apparatus of claim 9, wherein the processing circuitry is further configured to cause the apparatus to assign an object selection marker to the selectable video object, the object selection marker providing a visual indication of a presence of the selectable video object on a display rendering the video data.

11. The apparatus of claim 10, wherein the processing circuitry is configured to cause the apparatus to assign the object selection marker by enabling the operator to define different object selection markers to be displayed for respective different product types.

12. The apparatus of claim 9, wherein the processing circuitry is further configured to cause the apparatus to provide the video data to a service platform configured to provide network based distribution to a video consumer.

13. The apparatus of claim 9, wherein the processing circuitry is further configured to cause the apparatus to generate a media storage device storing the video data, the media storage device comprising a digital video disc or a Blu-ray disc.

14. The apparatus of claim 9, wherein the processing circuitry is configured to cause the apparatus to map the object by defining an information panel to be displayed responsive to selection of the selectable video object to implement the object function call.

15. The apparatus of claim 9, wherein the processing circuitry is configured to cause the apparatus to map the object by indicating a coordinate location of the object within an identified frame or at an identified time.

16. The apparatus of claim 9, wherein the processing circuitry is further configured to cause the apparatus to generate a searchable index of selectable video objects.

17. A method comprising:
receiving video data including both video media and an interactive video layer;
receiving a user input selecting a selectable video object from the interactive video layer during rendering of the video data, the selectable video object corresponding to an object mapped to a corresponding identifier associated with additional information about the object, the selectable object being selectable from the interactive video layer during rendering of the video data; and
executing an object function call corresponding to the user selectable video object, the object function call defining an action to be performed responsive to user selection of the selectable video object.

18. The method of claim 17, further comprising displaying an object selection marker proximate to the selectable video object, the object selection marker providing a visual indication of a presence of the selectable video object on a display rendering the video data.

19. The method of claim 18, further comprising enabling the user to define filter criteria by which to filter object selection markers to be displayed.

20. The method of claim 17, further comprising enabling the user to define at least one characteristic of the object selection marker.

21. The method of claim 17, further comprising enabling the user to define different filter object selection markers to be displayed for respective different product types.

22. The method of claim 17, wherein receiving the video data comprises receiving the video data from a service platform configured to provide network based distribution to a video consumer or from a media storage device storing the video data, the media storage device comprising a digital video disc or a Blu-ray disc.

23. The method of claim 17, further comprising displaying an information panel responsive to selection of the selectable video object, the information panel including at least one of a product image, a text description of the product, price information, or purchase information.

24. An apparatus comprising processing circuitry configured to cause the apparatus to perform at least:
receiving video data including both video media and an interactive video layer;
receiving a user input selecting a selectable video object from the interactive video layer during rendering of the video data, the selectable video object corresponding to an object mapped to a corresponding identifier associated with additional information about the object, the selectable object being selectable from the interactive video layer during rendering of the video data; and
executing an object function call corresponding to the user selectable video object, the object function call defining an action to be performed responsive to user selection of the selectable video object.

25. The apparatus of claim 24, wherein the processing circuitry is further configured to cause the apparatus to display an object selection marker proximate to the selectable video object, the object selection marker providing a visual indication of a presence of the selectable video object on a display rendering the video data.

26. The apparatus of claim 25, wherein the processing circuitry is further configured to cause the apparatus to enable the user to define filter criteria by which to filter object selection markers to be displayed.

27. The apparatus of claim 24, wherein the processing circuitry is further configured to cause the apparatus to enable the user to define at least one characteristic of the object selection marker.

28. The apparatus of claim 24, wherein the processing circuitry is further configured to cause the apparatus to enabling the user to define different filter object selection markers to be displayed for respective different product types.

29. The apparatus of claim 24, wherein the processing circuitry is configured to cause the apparatus to receive the video data by receiving the video data from a service platform configured to provide network based distribution to a video consumer or from a media storage device storing the video data, the media storage device comprising a digital video disc or a Blu-ray disc.

30. The apparatus of claim 24, wherein the processing circuitry is further configured to cause the apparatus to display an information panel responsive to selection of the selectable video object, the information panel including at least one of a product image, a text description of the product, price information, or purchase information.
